(19) United States
(12) Patent Application Publication
(10) Pub. No.: US 2008/0034412 A1
(43) Pub. Date: Feb. 7, 2008

(54) System to prevent misuse of access rights in a single sign on environment

(75) Inventor: Mark Wahl, Austin, TX (US)

Correspondence Address: Mark Wahl, PO Box 90626, Austin, TX, 78709, US

(73) Assignee: Informed Control Inc.

(21) Appl. No.: 11/497,646

(22) Filed: Aug. 2, 2006

(51) Int. Cl. G06F 17/30; H04L 9/32; G06F 15/16; G06F 7/04; G06F 7/58; G06K 9/00; G06K 19/00; H03M 1/68; H04K 1/00; H04L 9/00; H04N 7/16

(52) U.S. Cl. 726/8; 726/27

(57) ABSTRACT

A system which provides additional controls in access management for single sign on deployments, in order to restrict the range of resources in the deployment which could be accessed by an attacker, without unnecessarily burdening the user for their typical and legitimate use of these resources via single sign on. A misuse protection agent (12) intercepts access requests before they reach the target resource, and will check the status of the user for this resource in the database (28).

### BACKGROUND OF THE INVENTION

1. Field of Invention

This invention relates generally to the management of user access rights in enterprise computer networks.

2. Prior Art

Single sign on (SSO) technologies, such as those provided by Kerberos or in Web SSO products (i.e., Tivoli Access Manager, Sun ONE Identity Server, Netegrity SiteMinder, and other implementations of SAML and Project Liberty) simplify the end user's experience by only requiring the user to log in once per session (e.g., typically once per day), rather than individually for each application or resource the user will access. In principle, each application must still perform an authorization check for the authenticated user, even if it relies on the SSO infrastructure to have performed the authentication. However, with the growth of group and role-based access control deployments, the authorization check in practice might be as simple as verifying that the authenticated user is a member of a particular role.

U.S. Pat. No. 6,178,511 to Cohen, et al. (2001) describes a mechanism for single sign on across multiple resources. The system described in that patent maintains a database of user identity and authentication credentials (passwords) for each resource that the user would access. The system described in that patent is limited by not including any mechanism to control access to resources to an attacker that has gained knowledge of a user's primary password that controls access to the SSO database.

U.S. Pat. No. 6,807,636 to Hartman, et al. (2004) describes a framework for system in which user accesses to applications are intercepted by adapters, and these adapters generate security requests for authentication and/or authorization to a manager component. It does not describe how the manager component determines whether to grant the authentication or authorization request other than by use of a security policy, and the examples of security policies in that patent include “that an attribute request from an IIS oriented Web server should use the attributes stored in a Microsoft™ active directory and associated with users in the active directory security domain, accounting department”. The system described by that patent does not provide any determination of user authorization prior to access to a resource based on the history of the user's access to that resource, and as a result, the system described by that patent would not prevent an attacker who has stolen a user's authentication credentials from gaining access to all resources which have an authorization policy to permit that user access. Similar limitations are present in the system described in U.S. Pat. No. 6,275,944 to Kao et al.

U.S. Pat. No. 5,781,724 to Nevarez, et al. (1998) describes a system for integrating additional login components into an authentication system. In the authentication system, an authentication agent maintains state of whether a user has been authenticated or not, and an authentication service authenticates a user by checking the validity of the user's userid and password. The login extension components described in that patent are intended to provide additional functionality after the user has been authenticated, such as to perform virus scanning of the user's system, or to set up applications for the user to run on their system. That patent does not describe any mechanism to maintain state about which resources a user has accessed, and thus does not enforce controls on what actions an authenticated user could take. In particular, if an attacker gained control of a user's password, the system described in that patent would not be capable of detecting and blocking access requests from the attacker.

U.S. Pat. No. 6,941,472 to Moriconi, et al. (2005) describes a system in which policies are distributed to application guards located on client or server systems. In that patent, the policies are configured by the system administrator, and consist of a set of grant and deny rules based on user identity and role membership. The application guards may log to an audit log whether requests were granted or denied. The system described in that patent does not further leverage the information in this audit log, other than to allow the administrator to monitor it via a log viewer. That system is limited that it does not maintain state of user access request history and leverage that information in making determinations of whether further accesses should be allowed.

U.S. Pat. No. 6,928,547 to Brown, et al. (2005) describes a system for biometric authentication in which there can be multiple rules and filters for evaluating user authentication and access requests. In the system described in that patent, a “SAF/NT Validity Flag Sub-authentication filter” optional component checks whether a user was recently authenticated by a SAF server within a time interval of “1-2 seconds” prior to being authenticated by a “standard password security system” . The goal for this filter is to ensure that users login using their biometric and not by a password alone. This system described in that patent is limited in that it requires biometric login, which is not widely deployed in single sign on environments, and that it does not perform access control checks on each request to access a resource, only during authentication by a domain controller. As a result, the system described in that patent is not capable of detecting attacks in which an attacker gains control of a workstation where a user has already logged in (e.g., if the user has temporarily left their workstation unattended) and leverages that user's authenticated state to gain access to resources.

U.S. Pat. No. 7,016,959 to Dinh, et al. (2006) describes a system for self service single sign on management in which entries in a directory service representing mappings between users and resources are created and deleted. In the system described in that patent, the user must enter their userid and password that authenticates them to a resource when creating a linkage to that resource. The system described in that patent is limited in that user access to resources-is only deleted upon request by the user, and there is no mechanism described in that patent by which user access to infrequently-used resources can be disabled, or that the user would be required to re-authenticate to demonstrate they continue to need access to the resource.

U.S. Pat. No. 6,691,232 to Wood, et al. (2004) describes an architecture for single sign on authentication in which resources in a system may have differing security requirements. The architecture described by that patent is limited as the rules for determining authentication requirements must be configured by the administrator, and do not include checks for situations in which users have not recently accessed resources which they are entitled to access with the current level of authentication credentials.

### OBJECTS AND ADVANTAGES

The objective of this invention is to provide additional controls in access management for single sign on deployments, in order to restrict the range of resources in the deployment which could be accessed, without unnecessarily burdening the user for their typical and legitimate use of these resources via single sign on.

Two misuse scenarios are addressed in this invention. In one scenario, an attacker has gained a legitimate user's access (either by stealing or impersonating an SSO token or by guessing that user's password) and now has full access to the resources which that user has access. The attacker may be external, or may be another user within the organization (e.g., Bob has guessed Alice's password and is attempting to determine what Alice has access to). In the other scenario a user may attempt to access a wide range of resources in order to locate resources to which that user has inadvertently been granted access, based on the group or roles to which that user belongs. This invention will detect the attacker or user's attempt to access resources which the user has not recently accessed.

### SUMMARY

This invention consists of a system in which single sign on authentication and access control components are augmented with a misuse protection agent and database. This agent will detect forms of misuse of access rights that could indicate an attacker has gained control of a user's access token (e.g., a password), and notify an administrator to determine if access should be permitted.

### DRAWINGS—FIGURES

FIG. 1 contains a diagram illustrating the components of a system for preventing misuse of access rights.

FIG. 2 and FIG. 3 contain a flowchart which illustrates the algorithm of a misuse protection agent component (12).

FIG. 4 contains a flowchart which illustrates the algorithm of a resource administrator application component (20).

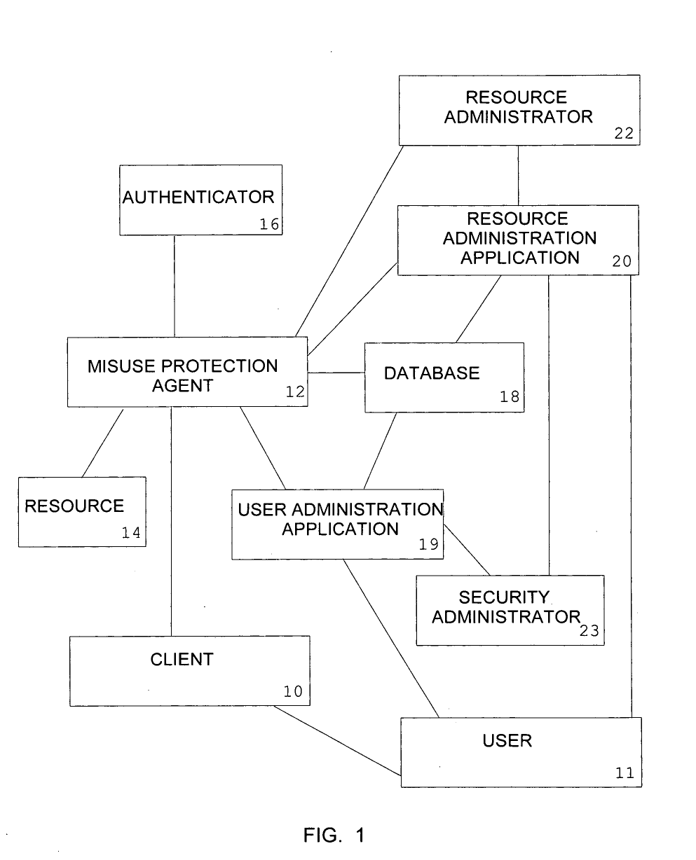

### DRAWINGS—REFERENCE NUMERALS

10 Client

11 User

12 Misuse Protection Agent

14 Resource

16 Authenticator

18 Database

19 User Administration Application

20 Resource Administration Application

22 Resource Administrator

23 Security Administrator

### DETAILED DESCRIPTION

The invention contains the following components:
A user (11) relies upon a client (10) application, such as a web browser, in order to obtain access to a resource (14), such as a web server or application server.
A misuse protection agent (12) intercepts access requests before they reach the target resource. As part of the single sign on system, it will rely on an authenticator component (16) to validate the client credentials or SSO token. That agent also uses a database (18) of user and resource parameters to determine whether to allow access, in the algorithm described below. A user may also view information from the database through a user administration application (19) to check if their account has been misused.
A resource administrator (22) will be contacted, such as via an electronic mail message, from a misuse protection agent (12) when it is necessary for a resource administrator to review a pending access request. That administrator will perform this function in a resource administration application (20), which will update a database (18) with the results of the review.
Denied accesses are reported by a resource administration application to a security administrator (23), such as via an electronic mail message.

Components 10, 12, 14, 16, 18, 19, 20 may be implemented as software running on general-purpose computer systems, or on special purpose devices attached to a network.

### Operation:

The approach taken in this invention requires storing in a database or databases the following information.
A database will contain, for each resource, the following parameters:

the maximum age (e.g., a number of days) for recent logins, contact method and address for the resource's resource administrator, and the contact method and address for the resource's security administrator. It will also contain a set of pending un-reviewed and postponed access requests.
A database will contain, for each user, the user's contact method, and the address for notifying the user of access grants (such as an email address). This information will typically be represented as attributes in a directory entry corresponding to that user.
A database will contain, for each resource that each user has attempted access, indexed by the combination of the user and resource, the following parameters: the last successful login date of that user to that resource, or a special value indicating “NEVER” if the user has never successfully logged into that resource; the last unsuccessful login date of that user to that resource, or a special value indicating “NEVER” if the user has never been unsuccessful in logging into that resource; a status indication, that if present contains the value “PENDING” or “LOCKOUT” (this indication parameter may be absent). (Note that in many existing single sign on products a last login date is associated with each user in general, but these products do not associate the last login dates for users at each resource the user has accessed).
Since the set of possible (user,resource) pairs is typically much larger than those which will be populated in practice for most deployments (as many resources will only be available to a few users), alternative implementation approaches for storing this third part of the database include: (1) a relational database table with columns USER and RESOURCE, both NOT NULL, as well as columns SUCCESSTIME, FAILURETIME, STATUS; (2) entries in a directory, located below each user's entry, that represent each resource the user has attempted access, containing the resource name, successful login time, failed login time, and status as attributes; and (3) entries in a directory, located below each resource's entry, that represent each user who has attempted access to that resource, and contains the user's name, successful login time, failed login time, and status as attributes. Approach (2) has the benefit of simpler implementation when extending existing SSO deployments, where there is already typically a directory service with a directory information tree containing entries that represent each user, however, it may not be possible due to the limitations of the directory server implementation (such as Active Directory) or administrative policy to place entries below each user's entry, and in these cases, Approaches (1) or (3) should be used instead.

In order to allow a user to determine if their account is being misused, particularly if they receive a notification that they have been permitted to access an account that they do not remember requesting, a user administration application (19) allows a user to view what systems they have recently accessed. This application is a resource that should itself be protected by the misuse protection agent. A view provided to a user should not display the full list of possible resources to the user, only those for which there has been a recent login attempt. (An administrator's view may provide more information, but this should be limited to authorized security administrators).

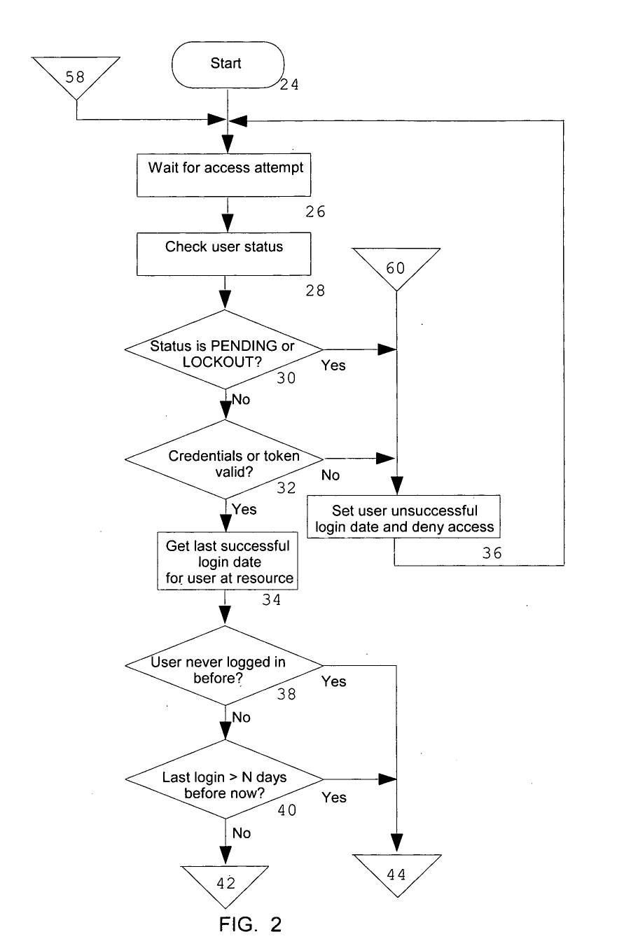

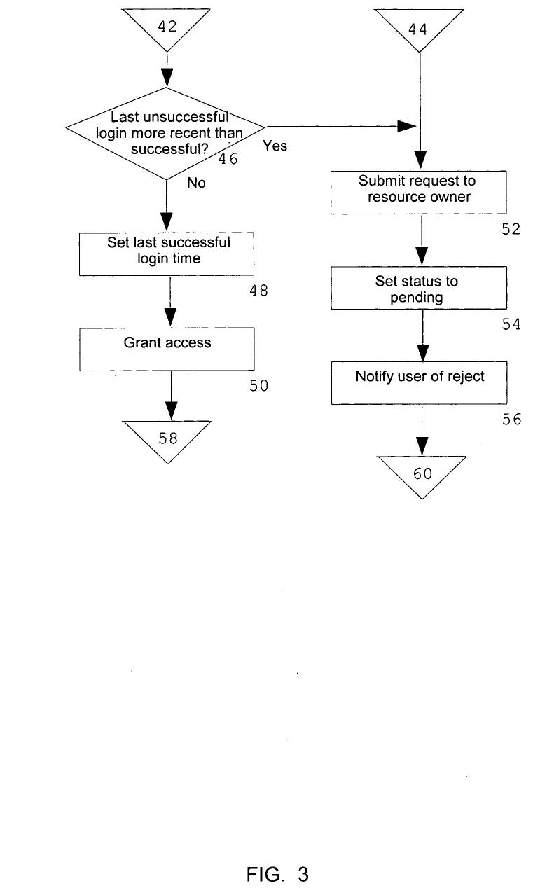

A misuse protection agent (12) implements the algorithm illustrated in the flowchart in FIG. 2 and FIG. 3. When a user attempts to access a resource, via a client presenting either the user's own authentication credentials or a SSO token, the misuse protection agent will intercept this access attempt (26) and will check the status of the user for this resource in a database (28). If the status is present with either the “PENDING” or “LOCKOUT” values (30), then the user is denied access to the resource and the user's last unsuccessful login date is set (36). Next, the agent will check the authentication token or credentials for the user (32). If they are invalid, then the agent will similarly deny access. Otherwise, the agent will check when the user has last successfully logged into that resource (36). If the value is “NEVER” (the user has not logged into the resource), then additional checks are made, which are described below at step 52. Similarly if the last successful login date is more than the configured age for the resource (40), or if the last unsuccessful login is more recent than the last successful login (46), these checks are made, as described at step 52. Otherwise the last successful login date is set to the current date (48), and user is permitted access to the resource (50).

If the perceived security threat for a particular deployment was limited to theft of an SSO token (e.g., from a browser window left open), then in principle a misuse protection agent for a resource could simply ignore a SSO token presented to the resource if the user has not recently successfully logged into that resource, and thus require a user to explicitly authenticate at that resource. However, this will be insufficient to stop an external attacker who has a user's credential (e.g., if the attacker has guessed the user's password) or a user who has legitimate knowledge of the credential and is “browsing” the resources available throughout the deployment, since a successful login, even a series of successful logins, are unlikely to trigger intrusion detection systems. Similarly, if the perceived security threat was limited to an attacker guessing a user's password or obtaining their SSO token, then in principle the misuse protection agent for a resource could ask the user for a secondary authentication token for the user, such as a secondary password or a challenge-response that is known only to the user and the system. This would slow down a potential attacker since they must next attempt to guess another password or the answer to the challenge. However, this technique will not deter a user who has configured that secondary password, or an external attacker who knows to reset such a secondary password before attempting access. (The methods of providing either challenge-response or a secondary authentication token are widely used on the Internet today to assist a user who has forgotten their password, but is not used for this specific purpose). Instead, the checks described below are used in this invention to address the misuse scenarios.

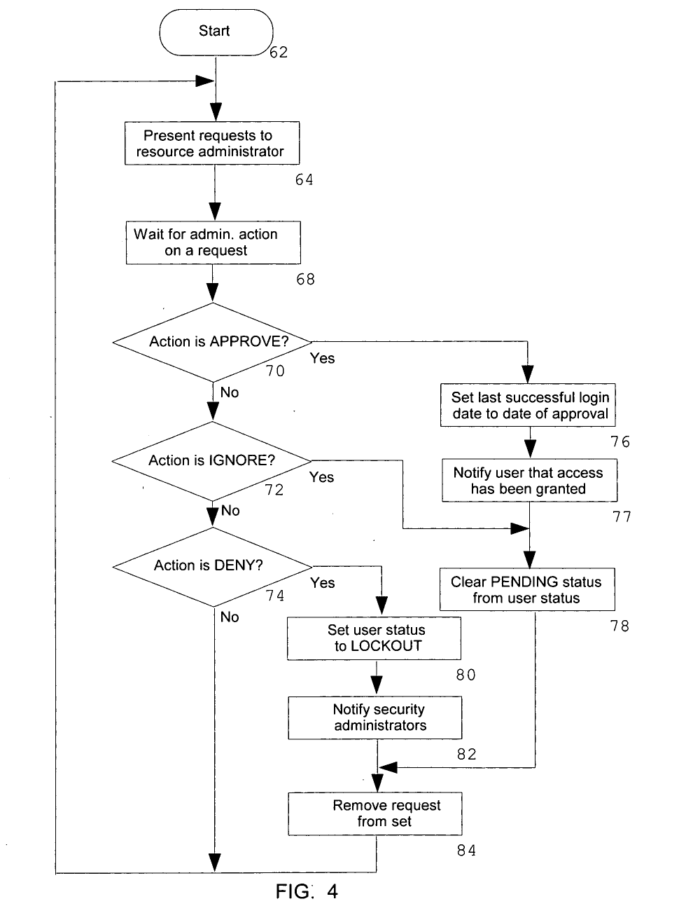

In order to address both misuse scenarios, it is necessary to have a resource-specific procedure for these security checks. Once a user has presented valid credentials, or has been authenticated with an SSO token, but before they are allowed access to the resource, if the last successful and unsuccessful login dates in the database indicate that additional security checks are to be made, then the additional security check at step 52 will be to submit a request to the owner of the resource, set the state to “PENDING” (54), inform the user why access is being denied (56), set the unsuccessful login date for the user at that resource, and then deny access. The request might take the form of an email, page or instant message to the resource administrator, that specifies the user who is requesting access, the date of the attempt, and invite the administrator to invoke the resource administration application (20) (e.g., a standalone application or a web-based one) where the administrator is permitted to select on the following actions to take on the request: approve it, deny it, ignore it, or postpone it, as described in the paragraph below. (As an alternative implementation, some pager systems allow the construction of simple query-response applications such as this one entirely within the pager itself, thus combining the resource administration application and misuse protection agent functionality into a single component.) The algorithm followed by the resource administration application (20) is illustrated by the flowchart in FIG. 4. An application will present the resource administrator with the set of requests for that resource (64), and wait for an administrator to select an action for each request (68).

If a resource administrator chooses to approve the request (70), the user's last login success date is set to the date of the approval, and the “PENDING” status is cleared, so that when the user next attempts access (assuming they do so within a reasonable time period) the additional checks will allow it. Additionally, an email or other notification might be sent to the user (77). This request will be removed from the set (84).

If a resource administrator chooses to ignore the request (72), the “PENDING” status is cleared, and the request is removed from the set, but the last login success date is not changed and the user is not notified, so that the procedure will be repeated if the user attempts to access the resource again.

If a resource administrator chooses to deny the request (74), the user's state on that resource is set to “LOCKOUT” (80), and a notification, such as an email message, is sent to the security administrators (82).

If a resource administrator chooses to take no action on this request, no change will be made to the user's status in the database, and the request will be postponed for the resource administrator to deal with later. Alternative Embodiments For some environments, the above technique by itself may result in a poor user experience due to long delays for accessing web sites that are legitimately but infrequently used. As an alternative implementation, the above steps can be amended as follows: when the user's request to access a resource has been approved by the resource administrator, the system can generate a random password, store in the record for this user and resource combination in the database, and provide it securely to the user as part of notification (77). Passwords in the databases should be stored in a non reversible form, so that theft of the database does not reveal the password information. For example, a SHA-1 hash combined with a random salt could be used. When next the user attempts access to that resource but has not logged into it recently, then before performing step 52, the user could be given the option of presenting that password. If the password matches, then the user's access is granted, otherwise it fails, the user is denied access and a request is sent to the resource administrator as described above at step 52. As these passwords are chosen by the misuse detection system rather than the user, and are specific to each resource, they are not easily guessable by an external attacker. This alternative, however, would not be suitable in deployments where the security policy is to avoid enabling users from accumulating access rights over time, or where the password will not be able to be transmitted or stored securely by the user, and internal attackers would have access to it.

### CONCLUSIONS

While the invention is described with reference to various implementations and exploitations, and in particular with respect to single sign on, it will be understood that these embodiments are illustrative and that the scope of the invention(s) is not limited to them. Terms such as “NEVER” are used to describe consistent states in a system, and transitory states may exist in physical implementations even if not presented by that system.

What is claimed is:

1. A method of restricting access in a single sign on environment, comprising:
(a) providing a resource which comprises a software application,
(b) providing a user which is a role for a human operator in said environment,
(c) providing a resource administrator which is a role for a human operator in said environment,
(d) providing a security administrator which is a role for a human operator in said environment,
(e) providing a client which is able to send an access request to said resource on behalf of said user,
(f) providing an agent which will intercept said access request before it reaches said resource,
(g) providing a database which is operationally connected to said agent for storing information on said resource, said user, said resource administrator, said security administrator, and said access request,
(h) providing a data access means which said resource administrator can interact with said database,
(i) providing a data access means which said security administrator can interact with said database,
whereby said agent will intercept said access request to determine whether said user has previously successfully accessed said resource within a predetermined time period, said agent will notify said resource administrator should said user have not successfully accessed said resource within said predetermined time period, said agent will reject said access request should said user have not successfully accessed said resource within said predetermined time period, and said resource administrator may update said database to set the time of last successful access.

2. The method of claim 1, wherein information in said database is made available to said agent through a structured query language.

3. The method of claim 1, wherein information in said database is made available to said agent through a directory access protocol.

4. The method of claim 1, wherein information in said database includes a secondary authentication credential that is specific for said user to access said resource.

5. The method of claim 1, wherein the means of communication from said agent to said resource administrator is the generation of an electronic mail message.

6. A machine for restricting access in a single sign on environment, comprising:
(a) a resource comprising a software application,
(b) a client which is able to send an access request to said resource on behalf of a user,
(c) an agent which will intercept said access request before it reaches said resource,
(d) an application for security administration for use by a security administrator,
(e) an application for resource administration for use by a resource administrator,
(f) a database which is operationally connected to said agent for storing information on said resource, said user, said resource administrator, said security administrator, and said access request,
whereby said agent will intercept said access request to determine whether said user has previously successfully accessed said resource within a predetermined time period, said agent will notify said resource administrator should said user have not successfully accessed said resource within said predetermined time period, said agent will reject said access request should said user have not successfully accessed said resource within said predetermined time period, and said resource administrator may update said database to set the time of last successful access.

7. The machine of claim 6, wherein said client, said agent, said database, and said application are implemented as software running on a general-purpose computer system.

8. The machine of claim 6, wherein said database is implemented as a relational database.

9. The machine of claim 6, wherein said database is implemented as a directory service.

10. The machine of claim 6, wherein said agent is implemented as software installed on a special purpose device attached to a network.
